(19) United States
(12) Patent Application Publication
(10) Pub. No.: US 2006/0210741 A1
(43) Pub. Date: Sep. 21, 2006

(54) Retortable packaging film with having seal/product-contact layer containing blend of polyethylenes and skin layer containing propylene-based polymer blended with polyethylene

(75) Inventor: Solomon Bekele, Taylors, SC (US)

Correspondence Address: Rupert B. Hurley Jr.;Sealed Air Corporation, P.O. Box 464, Duncan, SC, 29334, US

(73) Assignee: Cryovac, Inc.

(21) Appl. No.: 11/084,535

(22) Filed: Mar. 17, 2005

(51) Int. Cl. B32B 27/08

(52) U.S. Cl. 428/35.7; 428/35.2

(57) ABSTRACT

A retortable multilayer packaging film comprises a crosslinked first layer which serves as an outer heat seal/product contact layer, and a crosslinked second layer which serves as an outer heat seal/skin layer. The crosslinked first outer heat seal/product contact layer comprises a blend of a homogeneous ethylene/alpha-olefin copolymer and a heterogeneous ethylene/alpha-olefin copolymer and/r a propylene/ethylene copolymer having a melting point of from about 110° C. to about 150° C. and having up to 4.9 weight percent ethylene mer. The crosslinked outer heat seal/skin layer comprises a blend of: an isotactic propylene-based polymer, and a homogeneous ethylene/C₄₋₈ alpha-olefin copolymer having a density of from about 0.86 g/cc to about 0.91 g/cc. The invention also pertains to packaging articles made from the film, packaged products utilizing the film in the package, and a packaging process utilizing the film

### FIELD OF THE INVENTION

The present invention relates generally to packaging films, and more specifically to packaging films suitable for packaging food products which are to undergo retort while remaining inside the package.

### BACKGROUND OF THE INVENTION

Pouches made from films or laminates, including polymers such as polyethylene or polypropylene, have found use in a variety of applications. For example, such pouches are used to hold low viscosity fluids (e.g., juice and soda), high viscosity fluids (e.g., condiments and sauces), fluid/solid mixtures (e.g., soups), gels, powders, and pulverulent materials. The benefit of such pouches lies, at least in part, in the fact that such pouches are easy to store prior to filling and produce very little waste when discarded. The pouches can be formed into a variety of sizes and shapes.

Pouches can be assembled from films, laminates, or web materials using vertical form-fill-seal (VFFS) machines. Such machines receive the film, laminate, or web material and manipulate the material to form the desired shape. For example, one or more films, laminates, and/or web materials can be folded and arranged to produce the desired shape. Once formed, the edges of the pouch are sealed and the pouch filled. Typically, the film, laminate, or web material has at least one heat seal layer or adhesive surface which enables the edges to be sealed by the application of heat.

During the sealing process, a portion of at least one edge of the pouch is left unsealed until after the pouch is filled. The pouch is filled through the unsealed portion and the unsealed portion is then sealed. Alternatively, the pouch can be filled and the unsealed portion simultaneously closed in order to provide a sealed pouch with minimal headspace. The VFFS process is known to those of skill in the art, and described for example in U.S. Pat. No. 4,589,247 (Tsuruta et al), incorporated herein by reference. A flowable product is introduced through a central, vertical fill tube to a formed tubular film having been sealed transversely at its lower end, and longitudinally. The pouch is then completed by sealing the upper end of the tubular segment, and severing the pouch from the tubular film above it.

Retortable form fill and seal packaging can be carried out by providing a lap seal backseam and a bottom seal, followed by filling the resulting packaging article and thereafter sealing it closed and cutting it free of the film upstream. The packaged product is thereafter placed on a retort rack. The film needs to be capable of withstanding retort conditions and provide high flex crack and vibration induced abuse-resistance. The film also needs to be readily lap sealable (i.e., one outer film layer sealing to the other outer film layer), with the outer layer also being capable of avoiding undesirable sticking to the retort rack. Otherwise the pull force on the pouch will produce package damage. A high tack level on the outside of the film can also place undesirable drag on film processing equipment. An outside layer which readily seals to the inside layer generally also sticks to the retort rack and provides unwanted drag on film processing equipment. It would be desirable to have a retortable multilayer film which is readily lap sealable and also avoids sticking to the retort rack.

### SUMMARY OF THE INVENTION

The retortable multilayer film of the present invention utilizes an outer heat seal layer made from a blend of polyethylenes and an outer skin layer comprising a blend of a propylene-based polymer with a homogeneous ethylene/alpha-olefin copolymer. This combination of outer seal layer blend and outer skin layer blend provides a retortable film which can is readily lap-sealable but which does not stick to metal retort racks and does not provide too much drag on film processing equipment. Moreover, the outer layers of the film contain blends which also provide the film with impact strength and abuse resistance.

As a first aspect, the present invention is directed to a retortable multilayer packaging film comprising a crosslinked first layer which serves as an outer heat seal/product contact layer, and a crosslinked second layer which serves as an outer heat seal/skin layer.

The crosslinked first outer heat seal/product contact layer comprises a blend of:
(a) a homogeneous ethylene/octene copolymer having a density of from about 0.905 g/cc to about 0.93 g/cc, and/or
(b) a homogeneous ethylene/butene copolymer having a density of from about 0.90 g/cc to about 0.93 g/cc, and/or
(c) a homogeneous ethylene/hexene copolymer having a density of from about 0.90 g/cc to about 0.93 g/cc;

with
(d) heterogeneous ethylene/alpha-olefin copolymer having a density of from about 0.92 g/cc to about 0.95 g/cc, and/or
(e) propylene/ethylene copolymer having a melting point of from about 110° C. to about 150° C. and having up to 4.9 weight percent ethylene mer.

The crosslinked outer heat seal/skin layer comprises a blend of:
(f)) an isotactic propylene-based polymer, and
(g) a homogeneous ethylene/C₄₋₈ alpha-olefin copolymer having a density of from about 0.86 g/cc to about 0.91 g/cc

In a preferred embodiment, the outer heat seal/product contact layer comprises a heterogeneous ethylene/alpha-olefin copolymer having a density of from about 0.92 g/cc to about 0.94 g/cc.

In one preferred embodiment, the outer heat seal/product contact layer comprises propylene/ethylene copolymer having a melting point of from 110° C. to about 150° C. Preferably the propylene/ethylene copolymer contains from 0.1 to 4.9 weight percent ethylene mer.

In one preferred embodiment, the isotactic propylene-based polymer in the outer heat seal/skin layer includes a propylene homopolymer or a propylene/C₄₋₂₀ copolymer. This includes a propylene/ethylene copolymer in which the weight percent ethylene is in from about 0.1 to about 4.9. The propylene-based polymer preferably has a melting point of from about 125° C. to about 150° C. The propylene-based polymer can be a homogeneous polymer or a heterogeneous polymer. The propylene-based polymer can have a density of from about 0.88 to about 0.90 g/cc.

In one preferred embodiment, the multilayer film further comprises an O₂-barrier layer, with the grease-resistant layer being between the heat seal/product contact layer and the O₂-barrier layer. The O₂-barrier layer can comprise at least one member selected from the group consisting of crystalline polyamide, amorphous polyamide, ethylene/vinyl alcohol copolymer, vinylidene chloride copolymer, and polyacrylonitrile.

In one preferred embodiment, the heat seal/product contact layer comprises a blend of:
(i) at least one member selected from the group consisting of:
   (a) a homogeneous ethylene/octene copolymer having a density of from about 0.91 g/cc to about 0.93 g/cc; and
   (b) a homogeneous ethylene/butene copolymer having a density of from about 0.90 g/cc to about 0.91 g/cc; and
(ii) at least one member selected from the group consisting of:
   (a) a heterogeneous ethylene/alpha-olefin copolymer having a density of from about 0.92 g/cc to about 0.94 g/cc; and
   (b) a propylene/ethylene copolymer having a melting point of from about 115° C. to about 125° C.

In one preferred embodiment, the crosslinked heat seal/product contact layer further comprises a slip agent and an anti-blocking agent, and the crosslinked heat seal/skin layer further comprises a slip and anti-blocking agent.

In one preferred embodiment, the isotactic propylene-based polymer comprises homogeneous propylene/ethylene copolymer having a density of from about 0.88 g/cc to about 0.90 g/cc, and the homogeneous ethylene/C₄₋₈ alpha-olefin copolymer comprises homogeneous ethylene/butene copolymer having a density of from about 0.88 g/cc to about 0.905 g/cc.

In one preferred embodiment, the crosslinked heat seal/skin layer further comprises a slip agent and an antiblocking agent.

In one preferred embodiment, the retortable multilayer film further comprises a tie layer between the O₂-barrier layer and the crosslinked second layer.

In one preferred embodiment, the retortable multilayer film further comprises a grease-resistant layer between the O₂-barrier layer and the crosslinked first heat seal/product contact layer.

In one preferred embodiment, the grease-resistant layer also functions as a tie layer between the O₂-barrier layer and the crosslinked first layer.

In one preferred embodiment, the retortable multilayer film further comprises a first high-temperature abuse layer between the grease-resistant layer and the O2-barrier layer, and a second high-temperature abuse layer between the O₂-barrier layer and the crosslinked second heat seal/skin layer, each of the high-temperature abuse layers comprising a polymer having a Tg of from 50° C. to 125° C.

In one preferred embodiment, the retortable multilayer film further comprises a first low-temperature abuse layer between the grease-resistant layer and the first outer heat seal/product contact layer, and a second low-temperature abuse layer between the O₂-barrier layer and the second outer heat seal/skin layer, each of the low-temperature-abuse layers comprising a polymer having a T_{g} of up to 15° C.

In one preferred embodiment, the grease-resistant layer comprises at least one member selected from the group consisting of: (i) a crystalline anhydride-grafted C₂₋₃/C₆₋₂₀ alpha-olefin copolymer having a density of from 0.93 g/cc to 0.97 g/cc, (ii) a crystalline C₂₋₃/butene copolymer having a density of at least 0.92 g/cc, (iii) ionomer resin, and (iv) ethylene/unsaturated acid copolymer. Moreover, the first high-temperature-abuse layer and the second high-temperature-abuse layer each comprise at least one high-temperature-abuse polymer selected from the group consisting of seimcrystalline polyamide comprising at least one member selected from the group consisting of polyamide-6, polyamide-6,6, polyamide-6,9, polyamide-4,6, and polyamide-6,10. Still further, the first low-temperature-abuse layer and the second low-temperature-abuse layer each comprise at least one low-temperature-abuse polymer selected from the group consisting of olefin homopolymer, C₂₋₃/C₃₋₂₀ alpha-olefin copolymer, and anhydride-grafted ethylene/alpha-olefin copolymer. Finally, the tie layer comprises at least one member selected from the group consisting of anhydride grafted ethylene/alpha-olefin copolymer, ionomer resin, ethylene/unsaturated acid copolymer.

In one preferred embodiment, at least one of the high-temperature-abuse layers comprises a blend of the high-temperature-abuse polymer in a blend with at least one medium-temperature-abuse polymer selected from the group consisting of polyamide-6/6,6, polyamide-6,12, polyamide-6/6,9, polyamide-12, and polyamide-11.

In one preferred embodiment, the retortable multilayer film further comprises at least one medium-temperature-abuse layer that comprises at least one medium-temperature-abuse polymer having a glass transition temperature (i.e., Tg) of from 16° C. to 49° C. Preferred medium-temperature-abuse polymers include polyamide-6/6,6, polyamide-6,12, polyamide-6/6,9, polyamide-12, and polyamide-11.

As a second aspect, the present invention is directed to a retortable packaging article comprising a multilayer packaging film heat sealed to itself. The multilayer packaging film is in accordance with the first aspect of the present invention.

In one preferred embodiment, the crosslinked first heat seal/product contact layer is heat sealed to the crosslinked second layer (i.e., producing a lap seal).

In an alternative preferred embodiment, the crosslinked first heat seal/product contact layer is heat sealed to itself (i.e., producing a fin seal).

In one preferred embodiment, the multilayer packaging film is heat sealed to itself to form a member selected from the group consisting of end-seal bag, side-seal bag, pouch, and casing.

In a preferred embodiment, the article exhibits less than 19% leaking packages when filled with water, sealed closed and retorted at 250° F. for 90 minutes in a vibration table test in accordance with ASTM 4169 Assurance Level II for 30 minutes of vibration.

As a third aspect, the present invention is directed to a retortable packaged product comprising a product surrounded by a multilayer packaging film heat sealed to itself. The multilayer packaging film is in accordance with the first aspect of the invention.

As a fourth aspect, the invention is directed to a process of preparing a retorted packaged product, comprising: (A) placing a product in a packaging article comprising a multilayer packaging film heat sealed to itself; (B) sealing the article closed so that the product is surrounded by the multilayer packaging film; and (C) heating the packaged product to a temperature of at least 220° F. for a period of at least 1 hour. The multilayer packaging film is in accordance with the first aspect of the invention.

In one preferred embodiment, the product comprises at least one member selected from the group consisting of chili, rice, beans, olives, beef, pork, fish, poultry, corn, eggs, tomatoes, and nuts. The product can be any food, including meat, chicken broth, tomato-based products, etc.

In one preferred embodiment, the packaged product is heated to a temperature of at least 230° F. for a period of at least about 75 minutes.

In one preferred embodiment, the packaged product is heated to a temperature of at least 240° F. for a period of at least about 90 minutes.

In one preferred embodiment, the packaged product is heated to a temperature of at least 240° F. for a period of at least about 2 hours.

In one preferred embodiment, the packaged product is heated to a temperature of at least 250° F. for a period of at least about 90 minutes.

In a preferred embodiment, the food product in the package has a weight of from about 0.5 to about 10 kilograms, preferably about 3 to about 5 kilograms.

### DETAILED DESCRIPTION OF THE INVENTION

As used herein, the verb “to retort” refers to subjecting an article, such as a packaged food product, to sterilizing conditions of high temperature (i.e., of from 212° F. to 300° F.) for a period of from 10 minutes to 3 hours or more, in the presence of water, steam, or pressurized steam. As used herein, the phrase “retortable film” refers to a packaging film that can be formed into a pouch, filled with an oxygen-sensitive product, heat sealed, and retorted without delamination the layers of the film. The retort process is also carried out at elevated pressure. In general, the retort process is carried out with the packaged products being placed in an environment pressurized to from 20 to 100 psi. In another embodiment, from 30 to 40 psi.

As used herein, the term “film” is inclusive of plastic web, regardless of whether it is film or sheet. Preferably, films of and used in the present invention have a thickness of 0.25 mm or less. Preferably, the retortable film of the present invention has a thickness of from 2 to 15 mils, more preferably from 4 to 8 mils.

Preferably, the film of the present invention is produced as a fully coextruded film, i.e., all layers of the film emerging from a single die at the same time. Preferably, the film is made using a flat cast film production process or a round cast film production process. Alternatively, the film can be made using a blow film process.

The multilayer retortable film of the present invention can be either heat-shrinkable or non-heat shrinkable. If heat-shrinkable, the film can exhibit either monoaxial orientation or biaxial orientation. As used herein, the phrase “heat-shrinkable” is used with reference to films which exhibit a total free shrink (i.e., in both machine and transverse directions) of at least 10% at 185° F., as measured by ASTM D 2732, which is hereby incorporated, in its entirety, by reference thereto. If not heat shrinkable, the film can have been heat set during its manufacture. All films exhibiting a total free shrink of less than 10% at 185° F. are herein designated as being non-heat-shrinkable.

As used herein, the term “package” refers to packaging materials configured around a product being packaged. The phrase “packaged product,” as used herein, refers to the combination of a product which is surrounded by a packaging material.

As used herein, the phrases “inner layer” and “internal layer” refer to any layer, of a multilayer film, having both of its principal surfaces directly adhered to another layer of the film.

As used herein, the phrase “outer layer” refers to any film layer of film having less than two of its principal surfaces directly adhered to another layer of the film. The phrase is inclusive of monolayer and multilayer films. In multilayer films, there are two outer layers, each of which has a principal surface adhered to only one other layer of the multilayer film. In monolayer films, there is only one layer, which, of course, is an outer layer in that neither of its two principal surfaces are adhered to another layer of the film.

Once the retortable multilayer film is heat sealed to itself and thereby converted into a packaging article, one outer layer of the film is an inside layer of the article and the other outer layer becomes the outside layer of the article. The inside layer can be referred to as an “outer heat seal/product contact layer”. The other outer layer can be referred to as an “outer heat seal/skin layer”.

As used herein, the phrase “inside layer” refers to the outer layer of a multilayer film packaging a product, which is closest to the product, relative to the other layers of the multilayer film.

As used herein, the phrase “outside layer” refers to the outer layer, of a multilayer film packaging a product, which is furthest from the product relative to the other layers of the multilayer film. Likewise, the “outside surface” of a bag is the surface away from the product being packaged within the bag.

As used herein, the term “adhered” is inclusive of films which are directly adhered to one another using a heat seal or other means, as well as films which are adhered to one another using an adhesive which is between the two films.

As used herein, the phrases “seal layer,” “sealing layer,” “heat seal layer,” and “sealant layer,” refer to an outer film layer, or layers, involved in heat sealing of the film to itself, another film layer of the same or another film, and/or another article which is not a film. Heat sealing can be performed by any one or more of a wide variety of manners, such as using a heat seal technique (e.g., melt-bead sealing, thermal sealing, impulse sealing, ultrasonic sealing, hot air, hot wire, infrared radiation, etc.). A preferred sealing method uses the same double seal bar apparatus used to make the pressure-induced seal in the examples herein. A heat seals is a relatively narrow seal (e.g., 0.02 inch to 1 inch wide) across a film.

As used herein, the phrase “grease-resistant layer” refers to a film layer which is resistant to grease, fat, and/or oil, i.e., a layer which does not swell and delaminate from adjacent layers upon exposure to grease, fat, and/or oil during retorting of a package made using the film. The ability of a film to resist grease during retort is measured by packaging a high grease content food product in the film (e.g., corn oil, chili, etc) followed by retorting the packaged product. The retorted package is then inspected immediately at the conclusion of retort cycle, to determine if there has been any layer delamination. If no delamination, the product is stored and checked again one week later, and every two weeks thereafter for a total of at least 5 weeks from the date of retort. If no visible sign of delamination is present, the film is determined to be a grease-resistant film.

As used herein, the phrase “high temperature abuse layer” refers to a film layer containing a polymer capable of contributing substantial abuse resistance when the package is subjected to abuse while in the temperature range of from about 60° C. to about 180° C. Polymers capable of providing high temperature abuse resistance are polymers having a Tg of from 50° C. to 125° C. Preferred polymers for providing high temperature abuse resistance include semicrystalline polyamides, particularly polyamide-6, polyamide-6,6, polyamide-6,9, polyamide-4,6, and polyamide-6,10.

As used herein, the phrase “medium temperature abuse layer” refers to a film layer containing a polymer capable of contributing substantial abuse resistance when the package is subjected to abuse while in the temperature range of from about 20° C. to about 60° C. Polymers capable of providing medium temperature abuse resistance are polymers having a Tg of from 16° C. to 49° C. Preferred polymers for providing medium temperature abuse resistance include polyamide-6/6,6, polyamide-6,12, polyamide-6/6,9, polyamide-12, and polyamide-11.

As used herein, the phrase “low temperature abuse layer” refers to a film layer containing a polymer capable of contributing substantial abuse resistance when the package is subjected to abuse while in the temperature range of from about −50° C. to about 20° C. Polymers capable of providing low temperature abuse resistance are polymers having a Tg of up to 15° C. Preferred polymers for providing low temperature abuse resistance include olefin homopolymers, C₂₋₃/C₃₋₂₀ alpha-olefin copolymer, and anhydride-grafted ethylene/alpha-olefin copolymer.

One measure of abuse resistance for a package containing a flowable product is ASTM D 4169 “Standard Practice for Performance Testing of Shipping Containers and Systems”, which is hereby incorporated, in its entirety, by reference thereto. Of particular interest is “12. Schedule D—Stacked Vibration and Schedule E—Vehicle Vibration”, and still more particularly, Assurance Level II therein. This test method evaluates the ability of the package to undergo various vibrational frequencies for an extended period, which can cause flex cracking of a film surrounding a flowable product if the film does not exhibit satisfactory vibration abuse resistance. This test simulates transport of the package, particularly vehicular transport.

Another test for abuse resistance is known as the drop test. In testing the retortable and retorted packaged product of the present invention, the drop test is preferably carried out by dropping 10 identical retorted packages onto a concrete floor from a height of 3 feet. The packages are inspected for seal breaks and film rupture after each drop, and the percentage of leaking packages is noted.

The multilayer retortable packaging films of the present invention are preferably irradiated to induce crosslinking of all of the layers. Crosslinking the polymer in the layers improves the ability of the film to withstand retorting. Preferably the entire multilayer structure of the film is crosslinked, and preferably the crosslinking is induced by irradiation of the film. In the irradiation process, the film is subjected to an energetic radiation treatment, such as corona discharge, plasma, flame, ultraviolet, X-ray, gamma ray, beta ray, and high energy electron treatment, which induce cross-linking between molecules of the irradiated material. The irradiation of polymeric films is disclosed in U.S. Pat. No. 4,064,296, to BORNSTEIN, et. al., which is hereby incorporated in its entirety, by reference thereto. BORNSTEIN, et. al. discloses the use of ionizing radiation for crosslinking the polymer present in the film.

Radiation dosages are referred to herein in terms of the radiation unit “RAD”, with one million RADS, also known as a megarad, being designated as “MR”, or, in terms of the radiation unit kiloGray (kGy), with 10 kiloGray representing 1 MR, as is known to those of skill in the art. A suitable radiation dosage of high energy electrons is in the range of up to about 16 to 166 kGy, more preferably about 40 to 90 kGy, and still more preferably, 55 to 75 kGy. Preferably, irradiation is carried out by an electron accelerator and the dosage level is determined by standard dosimetry processes. Other accelerators such as a van der Graaf or resonating transformer may be used. The radiation is not limited to electrons from an accelerator since any ionizing radiation may be used.

As used herein, the term “bag” is inclusive of L-seal bags, side-seal bags, backseamed bags, and pouches. An L-seal bag has an open top, a bottom seal, one side-seal along a first side edge, and a seamless (i.e., folded, unsealed) second side edge. A side-seal bag has an open top, a seamless bottom edge, with each of its two side edges having a seal therealong. Although seals along the side and/or bottom edges can be at the very edge itself, (i.e., seals of a type commonly referred to as “trim seals”), preferably the seals are spaced inward (preferably ¼ to ½ inch, more or less) from the bag side edges, and preferably are made using a impulse-type heat sealing apparatus, which utilizes a bar which is quickly heated and then quickly cooled. A backseamed bag is a bag having an open top, a seal running the length of the bag in which the bag film is either fin-sealed or lap-sealed, two seamless side edges, and a bottom seal along a bottom edge of the bag. A pouch is made from two films sealed together along the bottom and along each side edge, resulting in a U-seal pattern. Several of these various bag types are disclosed in U.S. Pat. No. 6,790,468, to Mize et al, entitled “Patch Bag and Process of Making Same”, the entirety of which is hereby incorporated by reference. In the Mize et al patent, the bag portion of the patch bag does not include the patch.

The term “polymer”, as used herein, is inclusive of homopolymer, copolymer, terpolymer, etc. “Copolymer” includes copolymer, terpolymer, etc.

As used herein, the phrase “heterogeneous polymer” refers to polymerization reaction products of relatively wide variation in molecular weight and relatively wide variation in composition distribution, i.e., typical polymers prepared, for example, using conventional Ziegler-Natta catalysts. Heterogeneous copolymers typically contain a relatively wide variety of chain lengths and comonomer percentages. Heterogeneous copolymers have a molecular weight distribution (Mw/Mn) of greater than 3.0.

As used herein, the phrase “homogeneous polymer” refers to polymerization reaction products of relatively narrow molecular weight distribution and relatively narrow composition distribution. Homogeneous polymers are useful in various layers of the multilayer film used in the present invention. Homogeneous polymers are structurally different from heterogeneous polymers, in that homogeneous polymers exhibit a relatively even sequencing of comonomers within a chain, a mirroring of sequence distribution in all chains, and a similarity of length of all chains, i.e., a narrower molecular weight distribution. Furthermore, homogeneous polymers are typically prepared using metallocene, or other single-site type catalysis, rather than using Ziegler Natta catalysts.

More particularly, homogeneous ethylene/alpha-olefin copolymers may be characterized by one or more processes known to those of skill in the art, such as molecular weight distribution (Mw/Mn), Mz/Mn, composition distribution breadth index (CDBI), and narrow melting point range and single melt point behavior. The molecular weight distribution (Mw/Mn), also known as polydispersity, may be determined by gel permeation chromatography. The homogeneous ethylene/alpha-olefin copolymers useful in this invention generally has (Mw/Mn) of up to 3, more preferably up to 2.7; more preferably from about 1.9 to about 2.5; more preferably, from about 1.9 to about 2.3. The composition distribution breadth index (CDBI) of such homogeneous ethylene/alpha-olefin copolymers will generally be greater than about 70 percent. The CDBI is defined as the weight percent of the copolymer molecules having a comonomer content within 50 percent (i.e., plus or minus 50%) of the median total molar comonomer content. The CDBI of linear polyethylene, which does not contain a comonomer, is defined to be 100%. The Composition Distribution Breadth Index (CDBI) is determined via the technique of Temperature Rising Elution Fractionation (TREF). CDBI determination clearly distinguishes the homogeneous copolymers (narrow composition distribution as assessed by CDBI values generally above 70%) from VLDPEs available commercially which generally have a broad composition distribution as assessed by CDBI values generally less than 55%. The CDBI of a copolymer is readily calculated from data obtained from techniques known in the art, such as, for example, temperature rising elution fractionation as described, for example, in Wild et. al., J. Poly. Sci. Poly. Phys. Ed., Vol. 20, p. 441 (1982). Preferably, homogeneous ethylene/alpha-olefin copolymers have a CDBI greater than about 70%, i.e., a CDBI of from about 70% to 99%. In general, the homogeneous ethylene/alpha-olefin copolymers in the patch bag of the present invention also exhibit a relatively narrow melting point range, in comparison with “heterogeneous copolymers”, i.e., polymers having a CDBI of less than 55%. Preferably, the homogeneous ethylene/alpha-olefin copolymers exhibit an essentially singular melting point characteristic, with a peak melting point (Tm), as determined by Differential Scanning Calorimetry (DSC), of from about 30° C. to 130° C. Preferably the homogeneous copolymer has a DSC peak Tm of from about 80° C. to 125° C. As used herein, the phrase “essentially single melting point” means that at least about 80%, by weight, of the material corresponds to a single Tm peak at a temperature within the range of from about 60° C. to 110° C., and essentially no substantial fraction of the material has a peak melting point in excess of about 130° C., as determined by DSC analysis. DSC measurements are made on a Perkin Elmer System 7 Thermal Analysis System. Melting information reported are second melting data, i.e., the sample is heated at a programmed rate of 10° C./min. to a temperature below its critical range. The sample is then reheated (2nd melting) at a programmed rate of 10° C./min. The presence of higher melting peaks is detrimental to film properties such as haze, and compromises the chances for meaningful reduction in the seal initiation temperature of the final film.

A homogeneous ethylene/alpha-olefin copolymer can, in general, be prepared by the copolymerization of ethylene and any one or more alpha-olefin. Preferably, the alpha-olefin is a C₃-C₂₀ alpha-monoolefin, more preferably, a C₄-C₁₂ alpha-monoolefin, still more preferably, a C₄-C₈ alpha-monoolefin. Still more preferably, the alpha-olefin comprises at least one member selected from the group consisting of butene-1, hexene-1, and octene-1, i.e., 1-butene, 1-hexene, and 1-octene, respectively. Most preferably, the alpha-olefin comprises octene-1, and/or a blend of hexene-1 and butene-1.

Processes for preparing and using homogeneous polymers are disclosed in U.S. Pat. No. 5,206,075, U.S. Pat. No. 5,241,031, and PCT International Application WO 93/03093, each of which is hereby incorporated by reference thereto, in its entirety. Further details regarding the production and use of homogeneous ethylene/alpha-olefin copolymers are disclosed in PCT International Publication Number WO 90/03414, and PCT International Publication Number WO 93/03093, both of which designate Exxon Chemical Patents, Inc. as the Applicant, and both of which are hereby incorporated by reference thereto, in their respective entireties.

Still another genus of homogeneous ethylene/alpha-olefin copolymers is disclosed in U.S. Pat. No. 5,272,236, to LAI, et. al., and U.S. Pat. No. 5,278,272, to LAI, et. al., both of which are hereby incorporated by reference thereto, in their respective entireties. Each of these patents disclose substantially linear homogeneous long chain branched ethylene/alpha-olefin copolymers produced and marketed by The Dow Chemical Company.

As used herein, the phrase “ethylene/alpha-olefin copolymer”, and “ethylene/alpha-olefin copolymer”, refer to such materials as linear low density polyethylene (LLDPE), and very low and ultra low density polyethylene (VLDPE and ULDPE); and homogeneous polymers such as metallocene catalyzed polymers such as EXACT® resins obtainable from the Exxon Chemical Company, and TAFMER® resins obtainable from the Mitsui Petrochemical Corporation; and single site catalyzed Nova SURPASS® LLDPE (e.g., Surpass® FPS 317-A, and Surpass® FPS 117-C), and Sclair VLDPE (e.g., Sclair® FP112-A). All these materials generally include copolymers of ethylene with one or more comonomers selected from C₄ to C₁₀ alpha-olefin such as butene-1 (i.e., 1-butene), hexene-1, octene-1, etc. in which the molecules of the copolymers comprise long chains with relatively few side chain branches or cross-linked structures. This molecular structure is to be contrasted with conventional low or medium density polyethylenes which are more highly branched than their respective counterparts. The heterogeneous ethylene/alpha-olefins commonly known as LLDPE have a density usually in the range of from about 0.91 grams per cubic centimeter to about 0.94 grams per cubic centimeter. Other ethylene/alpha-olefin copolymers, such as the long chain branched homogeneous ethylene/alpha-olefin copolymers available from the Dow Chemical Company, known as AFFINITY® resins, are also included as another type of homogeneous ethylene/alpha-olefin copolymer useful in the present invention.

As used herein, the expression “C₂₋₃/C₃₋₂₀ copolymer” is inclusive of a copolymer of ethylene and a C3 to C20 alpha-olefin and a copolymer of propylene and a C4 to C20 alpha-olefin. Similar expressions are to be interpreted in a corresponding manner.

As used herein, the phrase “very low density polyethylene” refers to heterogeneous ethylene/alpha-olefin copolymers having a density of 0.915 g/cc and below, preferably from about 0.88 to 0.915 g/cc. As used herein, the phrase “linear low density polyethylene” refers to, and is inclusive of, both heterogeneous and homogeneous ethylene/alpha-olefin copolymers having a density of at least 0.915 g/cc, preferably from 0.916 to 0.94 g/cc.

As used herein, the term “bag” is inclusive of L-seal bags, side-seal bags, backseamed bags, and pouches. An L-seal bag has an open top, a bottom seal, one side-seal along a first side edge, and a seamless (i.e., folded, unsealed) second side edge. A side-seal bag has an open top, a seamless bottom edge, with each of its two side edges having a seal therealong. Although seals along the side and/or bottom edges can be at the very edge itself, (i.e., seals of a type commonly referred to as “trim seals”), preferably the seals are spaced inward (preferably ¼ to ½ inch, more or less) from the bag side edges, and preferably are made using a impulse-type heat sealing apparatus, which utilizes a bar which is quickly heated and then quickly cooled. A backseamed bag is a bag having an open top, a seal running the length of the bag in which the bag film is either fin-sealed or lap-sealed, two seamless side edges, and a bottom seal along a bottom edge of the bag. A pouch is made from two films sealed together along the bottom and along each side edge, resulting in a U-seal pattern. Several of these various bag types are disclosed in U.S. Pat. No. 6,790,468, to Mize et al, entitled “Patch Bag and Process of Making Same”, the entirety of which is hereby incorporated by reference. In the Mize et al patent, the bag portion of the patch bag does not include the patch. Packages produced using a form-fill-seal process are set forth in U.S. Pat. No. 4,589,247, discussed above.

Casings are also included in the group of packaging articles in accordance with the present invention. Casings include seamless tubing casings which have clipped or sealed ends, as well as backseamed casings. Backseamed casings include lap-sealed backseamed casings (i.e., backseam seal of the inside layer of the casing to the outside layer of the casing, i.e., a seal of one outer film layer to the other outer film layer of the same film), fin-sealed backseamed casings (i.e., a backseam seal of the inside layer of the casing to itself, with the resulting “fin” protruding from the casing), and butt-sealed backseamed casings in which the longitudinal edges of the casing film are abutted against one another, with the outside layer of the casing film being sealed to a backseaming tape. Each of these embodiments is disclosed in U.S. Pat. No. 6,764,729 B2, to Ramesh et al, entitled “Backseamed Casing and Packaged Product Incorporating Same, which is hereby incorporated in its entirety, by reference thereto.

### EXAMPLES 1-7

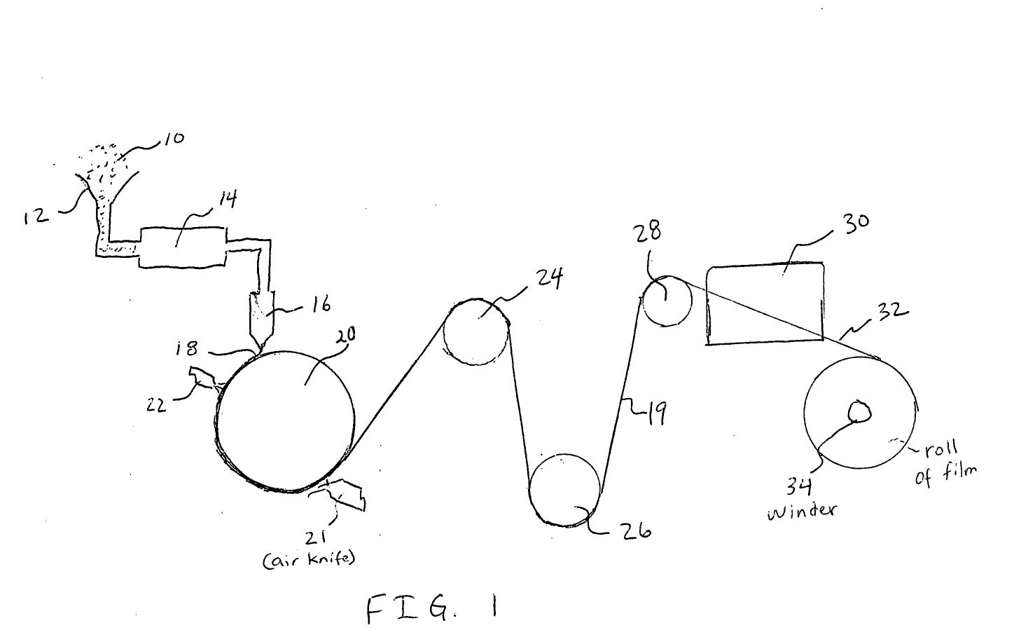

The following multilayer retortable films were prepared using the flat cast film production process illustrated in FIG. 1. Resin pellets 10 were fed into hopper 12 and melted, forwarded, and degassed in extruder 14. For convenience, only one hopper and extruder are illustrated in FIG. 1. However, there was one hopper and one extruder for each of the nine layers of the multilayer film being prepared. The molten streams from each of extruders 14 were fed into multilayer slot die 16, from which the streams emerged as multilayer extrudate 18. Multilayer extrudate 18 was cast downwardly from die 16 onto rotating casting drum 20, which had a diameter of about 43 inches and was maintained at 40° F.

Shortly after contacting casting drum 20, extrudate 18 solidified and was cooled by water from water knife 22, forming multilayer film 19. Multilayer film 19 passed in partial wrap around casting drum 20, being dried by air from air from air knife 21, and was thereafter passed in partial wrap around a first chill roll 24 and then in partial wrap around second chill roll 26. Chill rolls 24 and 26 had a diameter of about 18 inches and were maintained at room temperature. Multilayer film 19 then passed over feeder roller 28, and is illustrated as then being passed through irradiation chamber 30 and receiving 40 kGy of electron beam irradiation, resulting in retortable crosslinked multilayer film 32 and is wound up on winder 34. In reality, however, multilayer film 19 was first wound up, then unwound and fed through irradiation chamber 30 where it was subjected to 40 kGy of electron beam irradiation, resulting in retortable crosslinked multilayer film 32.

The layer composition, layer order, layer function, and layer thickness of each of the 9 layers for the films of Examples 1 through 7 are set forth in Table 1, below. The Table of Materials below Table 1 provides density, melt index, and generic chemical composition description of the various tradename resins set forth in Table 1.

TABLE 1
(Films of Examples 1, 2, 3, and 4)

| | | | | | | Layer | Layer | Layer | Layer |
|---|---|---|---|---|---|---|---|---|---|
| | | | | Layer | Layer | No. 6 | No. 7 | No. 8 | No. 9 |
| Film of | Layer | Layer | | No. 4 | No. 5 | (high | (tie and | (low | (seal and |
| Example | No. 1 | No. 2 | Layer | (high temp | (oxygen | temp | grease- | temp | food |
| Number | (skin) | (tie) | No. 3 | abuse) | barrier) | abuse) | resist) | abuse | contact) |
| 1 | Atofina | Mitsui | BASF | BASF | EMS | BASF | Equistar | Dow | Dow |
| | EOD01-03 | Admer | Ultamid | Ultramid | Grivory | Ultramid | Plexar | Elite | Dowlex |
| | (48%) | 1053A | C40 | B40 | G21 | B40 | 2246 | 5400G | 2037 |
| | ExxonMobil | | (Med | | | | (60%) | | (30%) |
| | Exact3128 | | temp | | | | Plexar | | Nova |
| | (44%) | | abuse) | | | | 2220 | | FPs |
| | SLIP/AB | | | | | | (40%) | | 317-A |
| | 8%) | | | | | | | | (63%) |
| | | | | | | | | | SLIP/AB |
| | | | | | | | | | (8%) |
| Mils | 1.0 | 0.30 | 0.40 | 0.60 | 0.30 | 0.60 | 0.50 | 0.9 | 1.41 |
| 2 | Atofina | Mitsui | Mitsui | BASF | EMS | BASF | Equistar | Dow | Dow |
| | EOD01-03 | Admer | Admer | Ultramid | Grivory | Ultramid | Plexar | Elite | Dowlex |
| | (48%) | 1053A | 1167A | B40 | G21 | B40 | 2246 | 5400G | 2037 |
| | ExxonMobil | | (tie) | (70%) | | (70%) | (60%) | | (30%) |
| | Exact3128 | | | Aegis | | Aegis | Plexar | | Nova |
| | (44%) | | | HCA73QP | | HCA73QP | 2220 | | FPs |
| | SLIP/AB | | | (30%) | | (30%) | (40%) | | 317-A |
| | 8%) | | | (Blend of | | (Blend of | | | (63%) |
| | | | | high & med | | high & | | | SLIP/AB |
| | | | | temp | | med temp | | | (8%) |
| | | | | abuse) | | abuse) | | | |
| Mils | 1.0 | 0.30 | 0.40 | 0.60 | 0.30 | 0.60 | 0.50 | 0.9 | 1.41 |
| 3 | Atofina | Mitsui | Mitsui | BASF | EMS | BASF | Equistar | Nova | Dow |
| | EOD01-03 | Admer | Admer | Ultramid | Grivory | Ultramid | Plexar | FPs | Dowlex |
| | (48%) | 1053A | 1167A | B40 | G21 | B40 | 2246 | 117-C | 2037 |
| | ExxonMobil | | (tie | (70%) | | (70%) | (60%) | | (30%) |
| | Exact3128 | | And | Aegis | | Aegis | Plexar | | Nova |
| | (44%) | | Low | HCA73QP | | HCA73QP | 2220 | | FPs |
| | SLIP/AB | | temp | (30%) | | (30%) | (40%) | | 317-A |
| | 8%) | | Abuse) | (Blend of | | (blend of | | | (63%) |
| | | | | high & med | | high & | | | SLIP/AB |
| | | | | temp | | med temp | | | (8%) |
| | | | | abuse) | | abuse) | | | |
| Mils | 1.0 | 0.30 | 0.40 | 0.60 | 0.30 | 0.60 | 0.50 | 0.9 | 1.41 |
| 4 | Atofina | Exxon | Mitsui | BASF | EMS | BASF | Equistar | Nova | Dow |
| | EOD01-03 | Mobil | Admer | Ultramid | Grivory | Ultramid | Plexar | FPs | Dowlex |
| | (48%) | ECD | 1053A | B40 | G21 | B40 | 2246 | 117-C | 2037 |
| | ExxonMobil | 364 | (tie | (70%) | | (70%) | (60%) | | (30%) |
| | Exact3128 | (Low | and | Aegis | | Aegis | Plexar | | Nova |
| | (44%) | temp | low | HCA73QP | | HCA73QP | 2220 | | FPs |
| | SLIP/AB | abuse) | temp | (30%) | | (30%) | (40%) | | 317-A |
| | 8%) | | Abuse) | (Blend of | | (Blend of | | | (63%) |
| | | | | high & med | | high & | | | SLIP/AB |
| | | | | temp | | med temp | | | (8%) |
| | | | | abuse) | | abuse) | | | |
| Mils | 1.0 | 0.30 | 0.30 | 0.60 | 0.30 | 0.60 | 0.50 | 0.9 | 1.41 |
| 5 | Atofina | Exxon | Mitsui | BASF | EMS | BASF | Equistar | Nova | Atofina |
| | EOD01-03 | Mobil | Admer | Ultramid | Grivory | Ultramid | Plexar | FPs | EOD03-01 |
| | (48%) | ECD | 1053A | B40 | G21 | B40 | 2246 | 117-C | (30%) |
| | ExxonMobil | 364 | (tie | (70%) | | (70%) | (60%) | | Nova |
| | Exact3128 | (Low | and | Aegis | | Aegis | Plexar | | FPs |
| | (44%) | temp | low | HCA73QP | | HCA73QP | 2220 | | 317-A |
| | SLIP/AB | abuse) | temp | (30%) | | (30%) | (40%) | | (63%) |
| | 8%) | | Abuse) | (Blend of | | (Blend of | | | SLIP/AB |
| | | | | high & med | | high & | | | (8%) |
| | | | | temp | | med temp | | | |
| | | | | abuse) | | abuse) | | | |
| Mils | 1.0 | 0.30 | 0.30 | 0.60 | 0.30 | 0.60 | 0.50 | 0.9 | 1.41 |
| 6 | Atofina | Exxon | Mitsui | BASF | EMS | BASF | Equistar | Nova | Dow |
| | EOD01-04 | Mobil | Admer | Ultramid | Grivory | Ultramid | Plexar | FPs | Dowlex |
| | (48%) | ECD | 1053A | B40 | G21 | B40 | 2246 | 117-C | 2037 |
| | ExxonMobil | 364 | (tie | (70%) | | (70%) | (60%) | | (30%) |
| | Exact3128 | (Low | and | Aegis | | Aegis | Plexar | | Nova |
| | (44%) | temp | low | HCA73QP | | HCA73QP | 2220 | | FPs |
| | SLIP/AB | abuse) | temp | (30%) | | (30%) | (40%) | | (63%) |
| | 8%) | | Abuse) | (Blend of | | (Blend of | | | SLIP/AB |
| | | | | high & med | | high & | | | (8%) |
| | | | | temp | | med temp | | | |
| | | | | abuse) | | abuse) | | | |
| Mils | 1.0 | 0.30 | 0.30 | 0.60 | 0.30 | 0.60 | 0.50 | 0.9 | 1.41 |
| 7 | Atofina | Exxon | Mitsui | BASF | EMS | BASF | Equistar | Nova | Finaplas |
| | EOD01-03 | Mobil | Admer | Ultramid | Grivoty | Ultramid | Plexar | FPs | 1571 |
| | (48%) | ECD | 1053A | B40 | G21 | B40 | 2246 | 117-C | (30%) |
| | ExxonMobil | 364 | (tie | (70%) | | (70%) | (60%) | | Nova |
| | Exact3128 | (Low | and | Aegis | | Aegis | Plexar | | FPs |
| | (44%) | temp | low | HCA73QP | | HCA73QP | 2220 | | 317-A |
| | SLIP/AB | abuse) | temp | (30%) | | (30%) | (40%) | | (63%) |
| | 8%) | | Abuse) | (Blend of | | (Blend of | | | SLIP/AB |
| | | | | high & med | | high & | | | (8%) |
| | | | | temp | | med temp | | | |
| | | | | abuse) | | abuse) | | | |
| Mils | 1.0 | 0.30 | 0.30 | 0.60 | 0.30 | 0.60 | 0.50 | 0.9 | 1.41 |

Table of Materials

| Material | Density | MI | Composition |
|---|---|---|---|
| Dowlex ® 2037 | 0.935 | 2.5 dg/min | Ziegler Natta |
| | | measured using | catalyzed |
| | | ASTM D1238, @ | ethylene/octene |
| | | 190° C. and 2.16 Kg | copolymer |
| Slip/AB = Slip | 0.95 | 1.8 dg/min | Slip and |
| and Antiblock | | measured using | antiblocking agents |
| Masterbatch = | | ASTM D1238, @ | in a Ziegler Natta |
| Ampacet ® | | 190° C. and 2.16 Kg | catalyzed linear low |
| 102729 | | | density |
| | | | polyethylene carrier |
| Atofina | 0.90 | 8.0(dg/min) | Metallocene |
| EOD01-03 | | measured using | catalyzed isotactic |
| | | ASTM D 1238 @ | polypropylene |
| | | 230° C. and 2.16 Kg | |
| Exxon | 0.90 | 1.0 dg/min | Metallocene |
| Exact ® 3128 | | measured using | catalyzed ethylene/ |
| | | ASTM D1238, @ | butene copolymer |
| | | 190° C. and 2.16 Kg | |
| Nova | 0.917 | 4.0 dg/min | Single site |
| FPs317A | | measured using | catalyzed |
| | | ASTM D1238, @ | ethylene/octene |
| | | 190° C. and 2.16 Kg | copolymer |
| Nova FPs 117-C | 0.917 | 1.0 dg/min | Single site |
| | | measured using | catalyzed |
| | | ASTM D1238, @ | ethylene/octene |
| | | 190° C. and 2.16 Kg | copolymer |
| Dow | 0.917 | 1.0 dg/min | metallocene |
| Elite ® 5400G | | measured using | catalyzed |
| | | ASTM D1238, @ | ethylene/octene |
| | | 190° C. and 2.16 Kg | copolymer |
| Admer | 0.91 | 1.0 dg/min | Anhydride grafted |
| AT1053A | | measured using | LLDPE tie |
| | | ASTM D1238, @ | |
| | | 190° C. and 2.16 Kg | |
| Admer | 0.91 | 2.0 dg/min | Anhydride grafted |
| AT1167A | | measured using | LLDPE tie |
| | | ASTM D1238, @ | |
| | | 190° C. and 2.16 Kg | |
| Equistar Plexar ® | 0.951 | 0.6 dg/min | Anhydride grafted |
| 2246 | | measured using | HDPE tie |
| | | ASTM D1238, @ | |
| | | 190° C. and 2.16 Kg | |
| Equistar Plexar ® | 0.943 | 5.5 dg/min | Anhydride grafted |
| 2220 | | measured using | HDPE tie |
| | | ASTM D1238, @ | |
| | | 190° C. and 2.16 Kg | |
| BASF B40 | 1.14 | — | PA-6 |
| EMS G21 | 1.18 | — | Amorphous |
| | | | PA-6I/6T |
| AEGIS | 1.13 | — | Semicrystalline |
| HCA73QP | | | PA-6/6,6 |
| Exxon ECD364 | 0.912 | 1.0 dg/min | Metallocene |
| | | measured using | catalyzed |
| | | ASTM D1238, @ | ethylene/hexane |
| | | 190° C. and 2.16 Kg | copolymer |
| Finaplas 1571 | 0.87 | 12(dg/min) | Homogeneous |
| | | measured using | syndiotactic |
| | | ASTM D 1238 @ | polypropylene |
| | | 230° C. and 2.16 Kg | |

Although the present invention has been described with reference to the preferred embodiments, it is to be understood that modifications and variations of the invention exist without departing from the principles and scope of the invention, as those skilled in the art will readily understand. Accordingly, such modifications are in accordance with the claims set forth below

What is claimed is:

1. A retortable multilayer packaging film comprising:
(A) a crosslinked first layer which serves as an outer heat seal/product contact layer, the first layer comprising a blend of:
(i) at least one member selected from the group consisting of:
(a) a homogeneous ethylene/octene copolymer having a density of from about 0.905 g/cc to about 0.93 g/cc;
(b) a homogeneous ethylene/butene copolymer having a density of from about 0.90 g/cc to about 0.93 g/cc; and
(c) a homogeneous ethylene/hexene copolymer having a density of from about 0.90 g/cc to about 0.93 g/cc; and
(ii) at least one member selected from the group consisting of:
(a) heterogeneous ethylene/alpha-olefin copolymer having a density of from about 0.92 g/cc to about 0.95 g/cc; and
(b) propylene/ethylene copolymer having a melting point of from about 110° C. to about 150° C. and having up to 5 weight percent ethylene mer;
(B) a crosslinked second layer which serves as an outer heat seal/skin layer, the second layer comprising a blend of
(i) an isotactic propylene-based polymer;
(ii) a homogeneous ethylene/C₄₋₈ alpha-olefin copolymer having a density of from about 0.86 g/cc to about 0.91 g/cc

2. The retortable multilayer packaging film according to claim 1, further comprising an O₂-barrier layer, with the grease-resistant layer being between the heat seal/product contact layer and the O₂-barrier layer.

3. The retortable multilayer packaging film according to claim 2, wherein the O₂-barrier layer comprises at least one member selected from the group consisting of crystalline polyamide, amorphous polyamide, ethylene/vinyl alcohol copolymer, vinylidene chloride copolymer, and polyacrylonitrile.

4. The retortable multilayer film according to claim 1, wherein the first layer comprises a blend of:
(i) at least one member selected from the group consisting of:
(a) a homogeneous ethylene/octene copolymer having a density of from about 0.91 g/cc to about 0.93 g/cc; and
(b) a homogeneous ethylene/butene copolymer having a density of from about 0.90 g/cc to about 0.91 g/cc; and
(ii) at least one member selected from the group consisting of:
(a) a heterogeneous ethylene/alpha-olefin copolymer having a density of from about 0.92 g/cc to about 0.94 g/cc; and
(b) a propylene/ethylene copolymer having a melting point of from about 115° C. to about 125° C.

5. The retortable multilayer film according to claim 1, wherein the first layer further comprises a slip agent and an anti-blocking agent, and the crosslinked second layer further comprises a slip and anti-blocking agent.

6. The retortable multilayer film according to claim 1, wherein the isotactic propylene-based polymer comprises homogeneous propylene/ethylene copolymer having a density of from about 0.88 g/cc to about 0.90 g/cc, and the homogeneous ethylene/C₄₋₈ alpha-olefin copolymer comprises homogeneous ethylene/butene copolymer having a density of from about 0.88 g/cc to about 0.905 g/cc.

7. The retortable multilayer film according to claim 1, wherein the crosslinked second layer further comprises a slip agent and an antiblocking agent.

8. The retortable multilayer film according to claim 2, further comprising a tie layer between the O₂-barrier layer and the crosslinked second layer.

9. The retortable multilayer film according to claim 8, further comprising a grease-resistant layer between the O₂-barrier layer and the crosslinked first layer.

10. The retortable multilayer film according to claim 9, wherein the grease-resistant layer also functions as a tie layer between the O₂-barrier layer and the crosslinked first layer.

11. The retortable multilayer film according to claim 9, further comprising a first high temperature abuse layer between the crosslinked first layer and the O₂-barrier layer, and a second high temperature abuse layer between the crosslinked second layer and the O₂-barrier layer.

12. The retortable multilayer film according to claim 11, further comprising a first low temperature abuse layer between the grease-resistant layer and the O₂-barrier layer, and a second low temperature abuse layer between the O₂-barrier layer and the skin layer.

13. The retortable multilayer film according to claim 12, wherein:
the grease-resistant layer comprises at least one member selected from the group consisting of:
(i) a crystalline anhydride-grafted C₂₋₃/C₆₋₂₀ alpha-olefin copolymer having a density of from 0.93 g/cc to 0.97 g/cc,
(ii) a crystalline C₂₋₃/butene copolymer having a density of at least 0.92 g/cc,
(iii) ionomer resin, and
(iv) ethylene/unsaturated acid copolymer;
the first high-temperature-abuse layer and the second high-temperature-abuse layer each comprise at least one high-temperature-abuse polymer selected from the group consisting of seimcrystalline polyamide comprising at least one member selected from the group consisting of polyamide-6, polyamide-6,6, polyamide-6,9, polyamide-4,6, and polyamide-6,10;
the first low-temperature-abuse layer and the second low-temperature-abuse layer each comprise at least one low-temperature-abuse polymer selected from the group consisting of olefin homopolymer, C₂₋₃/C₃₋₂₀ alpha-olefin copolymer, and anhydride-grafted ethylene/alpha-olefin copolymer;
the tie layer comprises at least one member selected from the group consisting of anhydride grafted ethylene/alpha-olefin copolymer, ionomer resin, ethylene/unsaturated acid copolymer.

14. The retortable multilayer film according to claim 13, wherein at least one of the high-temperature-abuse layers comprises a blend of the high-temperature-abuse polymer in a blend with at least one medium-temperature-abuse polymer selected from the group consisting of polyamide-6/6,6, polyamide-6,12, polyamide-6/6,9, polyamide-12, and polyamide-11.

15. The retortable multilayer film according to claim 13, further comprising a at least one medium-temperature-abuse layer that comprises at least one medium-temperature-abuse polymer selected from the group consisting of polyamide-6/6,6, polyamide-6,12, polyamide-6/6,9, polyamide-12, and polyamide-11.

16. A retortable packaging article comprising a multilayer packaging film heat sealed to itself, the multilayer packaging film comprising:
(A) a crosslinked first layer which serves as an outer heat seal and product contact layer, the first layer comprising a blend of:
(i) at least one member selected from the group consisting of:
(a) a homogeneous ethylene/octene copolymer having a density of from about 0.905 g/cc to about 0.93 g/cc;
(b) a homogeneous ethylene/butene copolymer having a density of from about 0.90 g/cc to about 0.93 g/cc; and
(c) a homogeneous ethylene/hexene copolymer having a density of from about 0.90 g/cc to about 0.93 g/cc; and
(ii) at least one member selected from the group consisting of:
(a) heterogeneous ethylene/alpha-olefin copolymer having a density of from about 0.92 g/cc to about 0.95 g/cc; and
(b) propylene/ethylene copolymer having a melting point of from about 110° C. to about 150° C.;
(B) a crosslinked second layer which serves as an outer heat seal and skin layer, the second layer comprising a blend of
(i) an isotactic propylene-based polymer;
(ii) a homogeneous ethylene/C₄₋₈ alpha-olefin copolymer having a density of from about 0.86 g/cc to about 0.91 g/cc

17. The retortable packaging article according to claim 16, in which the crosslinked first layer is heat sealed to the crosslinked second layer.

18. The retortable packaging article according to claim 16, in which the crosslinked first layer is heat sealed to itself.

19. The retortable packaging article according to claim 16, wherein the multilayer packaging film is heat sealed to itself to form a member selected from the group consisting of end-seal bag, side-seal bag, pouch, and casing.

20. The retortable packaging article according to claim 16, wherein the article exhibits less than 19% leaking packages when filled with water and sealed closed and retorted at 250° F. for 90 minutes and then subjected to a vibration table test in accordance with ASTM 4169 Assurance Level II for 30 minutes of vibration.

21. A retortable packaged product comprising a product surrounded by a multilayer packaging film heat sealed to itself, the multilayer packaging film comprising:
(A) a crosslinked first layer which serves as an outer heat seal and product contact layer, the first layer comprising a blend of:
(i) at least one member selected from the group consisting of:
(a) a homogeneous ethylene/octene copolymer having a density of from about 0.905 g/cc to about 0.93 g/cc;
(b) a homogeneous ethylene/butene copolymer having a density of from about 0.90 g/cc to about 0.93 g/cc; and
(c) a homogeneous ethylene/hexene copolymer having a density of from about 0.90 g/cc to about 0.93 g/cc; and
(ii) at least one member selected from the group consisting of:
(a) heterogeneous ethylene/alpha-olefin copolymer having a density of from about 0.92 g/cc to about 0.95 g/cc; and
(b) propylene/ethylene copolymer having a melting point of from about 110° C. to about 150° C.;
(B) a crosslinked second layer which serves as an outer heat seal and skin layer, the second layer comprising a blend of
(i) an isotactic propylene-based polymer;
(ii) a homogeneous ethylene/C₄₋₈ alpha-olefin copolymer having a density of from about 0.86 g/cc to about 0.91 g/cc

22. A process of preparing a retorted packaged product, comprising:
(A) placing a product in a packaging article comprising a multilayer packaging film heat sealed to itself, the multilayer packaging film comprising:
(1) a crosslinked first layer which serves as an outer heat seal and product contact layer, the first layer comprising a blend of:
(a) at least one member selected from the group consisting of:
(i) a homogeneous ethylene/octene copolymer having a density of from about 0.905 g/cc to about 0.93 g/cc;
(ii) a homogeneous ethylene/butene copolymer having a density of from about 0.90 g/cc to about 0.93 g/cc; and
(iii) a homogeneous ethylene/hexene copolymer having a density of from about 0.90 g/cc to about 0.93 g/cc; and
(b) at least one member selected from the group consisting of:
(i) heterogeneous ethylene/alpha-olefin copolymer having a density of from about 0.92 g/cc to about 0.95 g/cc; and
(ii) propylene/ethylene copolymer having a melting point of from about 110° C. to about 150° C.;
(2) a crosslinked second layer which serves as an outer heat seal and skin layer, the second layer comprising a blend of
(a) an isotactic propylene-based polymer;
(b) a homogeneous ethylene/C₄₋₈ alpha-olefin copolymer having a density of from about 0.86 g/cc to about 0.91 g/cc;
(B) sealing the article closed so that the product is surrounded by the multilayer packaging film; and
(C) heating the packaged product to a temperature of at least 220° F. for a period of at least 1 hour.

23. The process according to claim 22, wherein the product comprises at least one member selected from the group consisting of chili, rice, beans, olives, beef, pork, fish, poultry, corn, eggs, tomatoes, and nuts.

24. The process according to claim 22, wherein the packaged product is heated to a temperature of at least 230° F. for a period of at least about 75 minutes.

25. The process according to claim 24, wherein the packaged product is heated to a temperature of at least 240° F. for a period of at least about 90 minutes.
